(19) United States
(12) Patent Application Publication
(10) Pub. No.: US 2011/0126668 A1
(43) Pub. Date: Jun. 2, 2011

(54) NOTCHING DEVICE FOR CONTROL BOARD

(75) Inventor: Henry Beraud, Vincennes (FR)

(73) Assignee: VALEO SYSTEMES THERMIQUES, Le Mesnil Saint Denis (FR)

(21) Appl. No.: 12/675,287

(22) PCT Filed: Aug. 28, 2008
(86) PCT No.: PCT/EP08/61351

§ 371 Date: Apr. 14, 2010

(30) Foreign Application Priority Data
Aug. 28, 2007 (FR) 0706032

(51) Int. Cl. B23Q 16/02

(52) U.S. Cl. 74/813 R

(57) ABSTRACT

The invention relates to an indexation member (100) including a bearing (104) having an outline (106) and at least two indices (102) provided on the bearing (104), characterised in that the indices (102) are evenly distributed on the outline (106) of the bearing (104).

The invention relates to the field of control panels used for controlling various items of equipment, notably for motor vehicles.

It relates more particularly to a notching device making it possible to ensure indexation in order to keep a control member of a control panel in a chosen angular position.

Control panels comprise a board, at least one control member, or button, mounted so as to rotate on the board about an axis and comprising a notched ring furnished with notches, and an indexing member supported by the board and arranged to interact with the notches.

Control panels of this type are already known which comprise at least one control member which can be moved into any one of a plurality of chosen angular positions, or indexed positions, in which the indexing member, on each occasion, interacts with a notch of the notched ring. This makes it possible to define a succession of different positions which correspond on each occasion to a particular value of adjustment of the equipment that is controlled by the panel. Such a control panel is, for example, taught by French patent application FR2872744-A1.

Such control panels find an application in many fields, such as radio, navigation, telephony, etc. These panels may be used in particular in the automobile field in order to control an item of equipment, notably a heating, ventilation and/or air conditioning device of the interior of a motor vehicle.

In this particular application, the control panel may comprise, for example, a button for controlling the temperature of the interior, a button for adjusting the air flow rate and a button for adjusting the distribution of the delivery of the air flow circulating in the interior. If the temperature of the interior can be adjusted according to various zones, the number of buttons may be increased in order to ensure the independent adjustment of the air flows delivered to the various zones.

These devices comprise an indexing member made in the form of a leaf spring, also called a “notching leaf” interacting with the notches of the notched ring in order to define a certain number of indexed positions or number of clicks. It is also known practice to achieve the indexing via a ball operated by a spring acting on the notches of the notched ring.

In all cases, the known indexing members create unnecessary radial and axial forces on the notched ring. These forces cause an imbalance of the notched ring generating frictions that can adversely affect the rotation of the control member. This creates unnecessary handling forces which do not promote a pleasant feeling for the end user who must handle the control members of a control panel as described in the preamble.

Moreover, the known devices often require notching leaves that are straight and elongated and comprising bulky coupling means. They therefore require space for their installation and also for mounting. Moreover, the receiving board must be worked accordingly.

It is therefore desirable that such indexing devices are simple to produce and easy to mount.

Moreover, the indexing devices must satisfy the requirements of cost and haptic feel. Specifically, they must be made on the one hand economically and at low cost and, on the other hand, have a “noble” or “soft” notching as is known for example in the case of the control buttons of a hi-fi system, in particular with control buttons having a fairly large diameter.

The indexing of the control buttons of hi-fi systems is complex and costly.

The object of the present invention is notably overcome the aforementioned drawbacks.

For this reason, the invention proposes an indexing member comprising a support having a contour and at least two position locators arranged on the support, characterized in that the position locators are equally distributed over the contour of the support, characterized in that the position locators are placed on respective deformable members having a free end.

The position locators are equally distributed over the contour of the support.

According to one embodiment, the support is a frame having an inner contour.

Optionally, the position locators are placed on respective deformable members. These deformable members are deformable zones made by a portion of an inner partition having a free end or by one or more arms with a free end.

The deformable zones may comprise a cut capable of ensuring the deformation of the portion of inner partition.

According to another aspect, the arm comprises a fixed end attached to the frame and an end free of any connection with the frame.

According to a particular embodiment, at least two arms are linked in pairs to the frame by means of a join.

To obtain a notching that is yet more gentle, it has been found useful to provide three, or even four arms linked to the frame by means of joins in order to reduce the notching force for each position locator.

If four arms are provided, the latter are linked in pairs to the frame by means of joins.

The frame takes, for example, the form of a parallelogram, in particular a square, or a circular form.

Alternatively, the position locators are asymmetrical.

The object of the present invention is in particular to produce a control panel of the type defined in the introduction, the indexing member of which has an agreeable feel with no unnecessary force. Similarly, the indexing member is easily made and produced at low cost. Finally, the latter is easy to mount on the board of the control panel.

By virtue of the invention, it is possible to produce an indexing member that is simple and reliable. It is therefore possible to place the position locators precisely relative to the indexing means in order to dispense with manufacturing clearances and tolerances. Such a device can be easily produced by molding processes.

Moreover, through a judicious choice of the materials employed to produce the indexing member, the sliding of the position locators on the notches is made easier.

This avoids the use of greasing or of any other lubrication means.

The present invention also makes it possible to have a soft and noiseless feel.

It is moreover easy, thanks to the present invention, to obtain an evenness of feel as a function of the number of notches irrespective of the diameter of the rotary buttons. It is also possible to adapt the number and shape of the notches easily while retaining a reduced space requirement.

It is also an object of the invention to propose a control panel comprising at least one indexing member as described above.

A further object is to produce a control panel which finds an application in many technical fields, and notably in the field of motor vehicle equipment, in particular the heating, ventilation and/or air conditioning installations.

The control panel, in particular for a heating, ventilation and/or air conditioning installation comprises notably an indexing member as defined above.

Alternatively or additionally, the control panel comprises at least one button capable of being rotated manually by a user, in one direction or the other, about respective axes of rotation which extend perpendicularly to the general plane of a board.

According to the various embodiments, the button comprises a toothed ring comprising notches interacting with the position locators of the indexing member.

Preferably, the indexing member is mounted on the board by attachment means such as screws or rivets.

Other advantages and features of the invention will appear on reading the following description. This description is purely illustrative and given as an example and must be read with reference to the appended drawings which show:

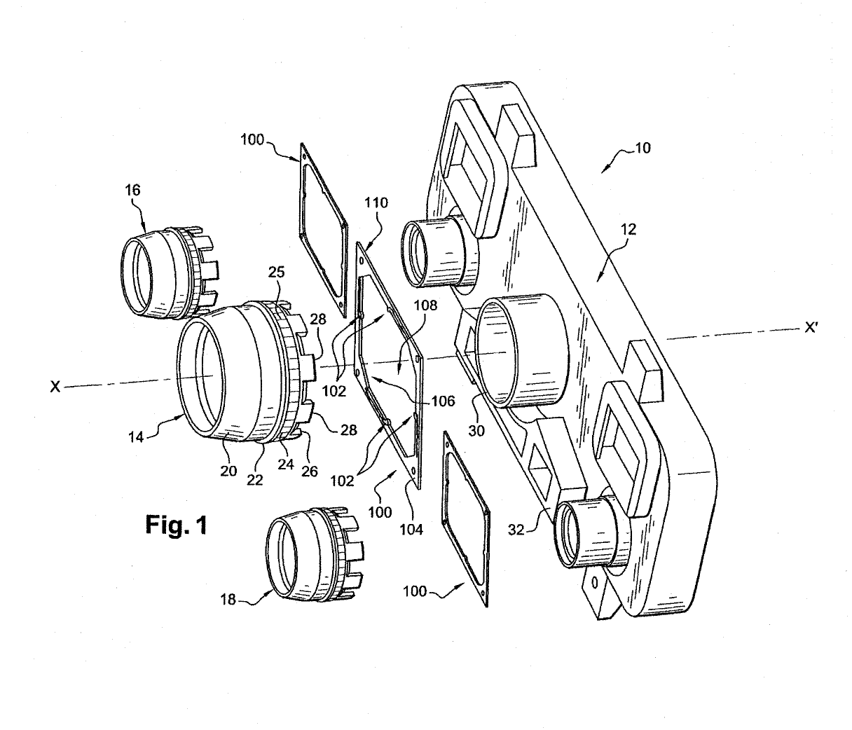

in FIG. 1, an exploded view in perspective of a control panel comprising three buttons with positions indexed according to the invention,

in FIG. 2, a view in section from above of an indexing member according to a first embodiment,

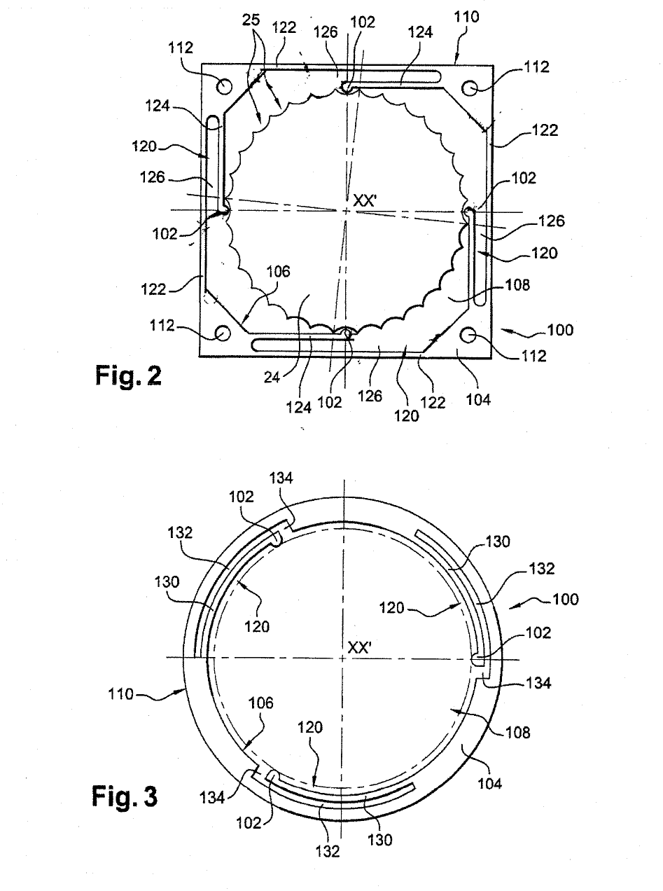

in FIG. 3, a view in section from above of an indexing member according to a second embodiment, and

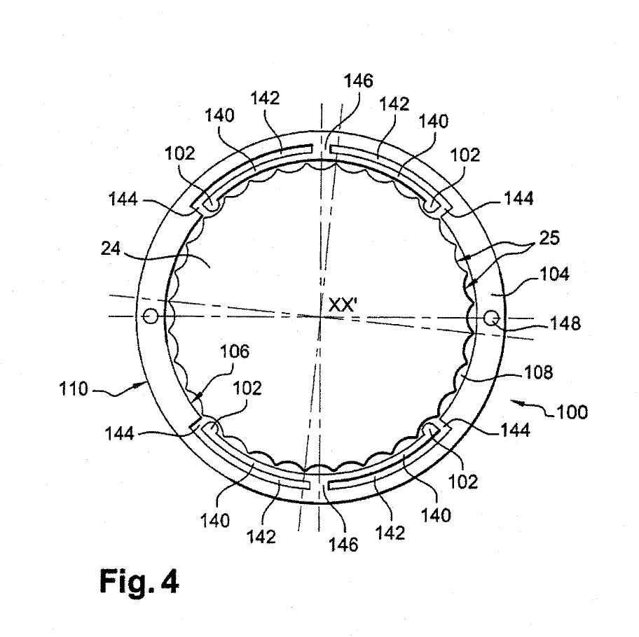

in FIG. 4, a view in section from above of an indexing member according to a second embodiment.

Reference is made first to FIG. 1 which shows a control panel, designated in its entirety by reference No. 10. and comprising a board 12, of generally flat shape on which are mounted in the example, three rotary buttons. A first button 14 is placed in a central region of the board. A second button 16 and third button 18 are situated on either side of the button 14. These buttons are arranged so as to be rotated manually by a user in one direction or the other about respective axes of rotation which extend perpendicularly to the general plane of the board.

According to the exemplary embodiment described, the board 12 of the control panel is substantially flat and the axis of rotation of the button extends perpendicularly to this plane. Nevertheless, different geometric conformations could be envisaged to which the present invention is equally applicable.

In a preferred exemplary embodiment, this control panel is designed to be mounted on the fascia of a motor vehicle in order to control various parameters associated with an item of equipment of this vehicle, in particular a heating, ventilation and/or air conditioning installation of the interior of a vehicle.

In the particular case of a heating, ventilation and/or air conditioning installation of the interior of a vehicle, the buttons 14, 16 and 18 may serve, for example, to adjust respectively the temperature, the air flow rate and the distribution of delivery of an air flow into an interior of a motor vehicle.

In the rest of the description, only button 14 will be described in detail. The buttons 16 and 18 are made in a manner similar to the latter.

The button 14 comprises a body 20, which may, according to a variant embodiment, be striated in order to make it easier to grasp by the user. This body 20 is extended by an abutment ring 22 interacting with the surface of a facade (not shown) in order to retain the button 14 axially. After the abutment ring 22, a notched ring 24 and a toothed ring 26 defining a plurality of axial teeth 28 are placed respectively one after the other.

The button 14 is hollow and is designed to be engaged around a cylindrical barrel 30 coming out of the board 12 extending on an axis XX′. The button 14 is mounted so as to be able to rotate about the axis XX′ of the cylindrical barrel 30. This is then called a button with an axis 30 of large diameter (that is to say that the diameter of the barrel is in the same orders of magnitude or larger than the height of the barrel) and hollow which makes it possible, on the one hand, to obtain a better firmness and, on the other hand, the insertion of central buttons for example of the “push” type.

According to one exemplary embodiment, the teeth 28 of the button 14 interface with walls 32 arranged on the board 12 and housing an encoding device (for example an optical encoder). The encoding device is placed on an electronic circuit (not shown) arranged behind the board 12 in order to perform an encoding function.

In the exemplary embodiment, the encoding function is performed by an optical encoder. In this configuration, apertures are made in the walls 32 in order to allow light beams to pass which are interrupted by the teeth 28 of the button 14 when the latter is turned.

The button 14 can be kept in a chosen angular position by interaction of an indexing device formed of an indexing member 100 and notches 25 of the notched ring 24. The indexing member 100 will be explained in detail more precisely with respect to FIGS. 2 to 4.

According to various embodiments, the notches may be in the form of waves, bosses or recesses.

FIG. 2 is a view in section from above of the indexing member 100 according to a first embodiment as placed in the control panel 10 of FIG. 1.

The indexing member 100 comprises a support arranged in the form of a frame 104 having an outer contour 110 and an inner contour 106. According to the present exemplary embodiment, the frame 104 is closed and defines an aperture 108 for the notched ring 24 to pass through. Nevertheless, according to an alternative covered by the present invention, the frame 104 may be partially open.

According to this first embodiment, the frame 104 takes the form of a parallelogram, in particular a square.

The inner contour 106 comprises position locators 102 interacting with the notches 25 of the notched ring 24. In FIG. 2, the position locators are made in the form of inner partitions 124 with a free end and are four in number. However, the position locators may take other forms and be more than four in number. As a minimum, the position locators are two in number, distributed symmetrically.

The position locators 102 are equally distributed over the inner contour 104. Specifically, the defined angle, the apex of which is on the axis XX′ and between two successive position locators 102, is 90°.

The equal distribution of the position locators 102 is defined by a uniform placing of the position locators 102 on the inner contour 104. The angle between two successive indicators is identical irrespective of the chosen pair of successive position locators. Therefore, if N position locators are distributed over the inner contour 106, the angle between two successive position locators is 360°/N.

Such a placement makes it possible to have a balance of forces exerted by the position locators 102 on the notched ring 24 when the latter is handled. Therefore, the vectorial total of the forces is zero and the bary center of the indexing member is on the axis XX′ of rotation of the notched ring 24.

Moreover, in order to enhance the feel when the buttons 14, 16 and 18 are used, the number of notches 25 of the notched ring 24 is defined so that in all indexing positions, the position locators 102 are placed in a notch 25. In the example described, the notched ring 24 comprises thirty-two notches 25.

Usually, the number of notches is a multiple of the number of position locators. The shape and dimension of the position locators are suitable for obtaining the greatest possible compactness. Moreover, the size of the position locators may be chosen to be sufficiently small to interfere with and enter the shape and geometry of the notches.

In order to make the handling of the buttons 14, 16 and easier, the position locators 102 are placed on respective deformable members. In FIG. 2, the deformable members are produced by the deformable zones. More precisely, the deformable zones are obtained from the formation of a portion of inner partition 124 having a deformable free end arranged in the frame 104 of the indexing member 100. This portion of partition 124 is delimited between the inner contour 106 of the indexing member 100 and a cut 126 made through the frame 104 in the vicinity of its outer contour 110. The presence of this cut 126 allows the portion of inner partition 124 to retract when the position locator 102 placed on the latter passes over the apex separating two successive notches 25. The cut 126 is made through the frame 104 of the indexing member 100 in order to arrange a recess of material capable of being occupied by the inner partition 124 when it is deformed.

Preferably, the frame 104 comprises a plurality of deformable zones 120 which are arranged on its periphery, while being placed substantially in a centered manner relative to the position locators 102.

According to the embodiment of FIG. 2, the cuts 126 made in the frame 104 of the indexing member 100 are drillings or stampings. They thus define the deformable portions of inner partitions 124 situated between the inner contour 106 and the cut 126 and the outer partitions 122 placed between the cut 126 and the outer contour 110.

When the button 14, respectively the buttons 16 and 18, is rotated, the position locators 102 follow the curvature of the notches 25 of the notched ring 24. Thus, they come into contact with the apex separating two successive notches 25 compressing the deformable zone 120 in order to mark the passage from one position to another. Moreover, when the button 14 is rotated, the elasticity of the deformable zone 120 performs an action tending to bring the position locators 102 into the hollow of a notch 25. It thus prevents a position locator 102 being held in an unstable position on the apex separating two successive notches 25.

Finally, for the installation and retention in position of the indexing member 100 on the board 12 of the control panel 10, holes 112 are placed in a distributed manner on the frame 104 in order to allow the passage of attachment means, such as screws, rivets or clips.

Reference is now made to FIG. 3 in order to describe more particularly a view in section from above of an indexing member according to a second embodiment.

In this second embodiment, the frame 104 has a circular shape. Such an arrangement makes it possible to reduce the size of the indexing member 100. Specifically, the circular shape of the frame 104 makes it possible to minimize the space of the aperture 108 which is not occupied by the notched ring 24, symbolized in dot-and-dash line in FIG. 3.

Moreover, according to the exemplary embodiment shown in FIG. 3, three position locators 120 are distributed evenly over the inner contour 106 of the frame 104 of the indexing member 100. The position locators 120 according to the arrangement of FIG. 3 are 120° apart.

The position locators 102 of the inner contour 106 interact with the notches 25 of the notched ring 24 and are placed on respective deformable members 120 made by arms 130. The arms 130 are made in the form of a deformable inner partition arranged in the frame 104 of the indexing member 100 on the inner contour 106. More particularly, each arm 130 comprises a fixed end attached to the frame 104 and an end free of any connection with the frame 104. This free end supports the position locator 102. The arm 130 is detached from the frame 104 by a gap 132 between the arm 130 and the section of frame 104 defining the outer contour 110.

The geometric arrangement of the arm 130 allows an elastic movement of its free end. Consequently, the position locator 102 can move so as to allow the passage from one position to another without creating unnecessary forces.

When the button 14, respectively the buttons 16 and 18, is rotated, the position locators 102 follow the curvature of the notches 25 of the notched ring 24. Thus, they come into contact with the apex separating two successive notches 25 compressing the arm 130 in order to mark the passage from one position to another. Moreover, the elasticity of the arm 130 prevents a position locator 102 from being held in an unstable position on the apex separating two successive notches 25 when the button 14 is rotated.

Reference is now made to FIG. 4 in order to describe more particularly a third variant shown in a view in section from above of the indexing member according to the present invention.

The exemplary embodiment of FIG. 4 is a variant of the arrangement of the indexing member of FIG. 3 comprising four position locators 102 distributed over the inner contour 106 of the frame 104 of the indexing member 100.

An interaction is ensured between the position locators 102 of the inner contour 106 and the notches 25 of the notched ring 24. Arms 140 form the respective deformable members 120. They are similar to the arms 130 described with reference to FIG. 3.

The arms 140 are linked in pairs to the frame 104 of the indexing member 100 by means of a join 146. The joins 146 attach the fixed ends of each arm to the frame 104 of the indexing member 100.

On either side of the joins 146, gaps 142 are arranged between the arms 140 and the section of frame 104 defining the outer contour 110. These gaps 146 make it possible to detach the arms 140 from the frame 104.

In a manner similar to the degrees of freedom of the arm 130 according to the arrangement of FIG. 3, the arms 140 have an elastic deformation of their free ends so that the position locators 102 can move so as to allow the passage from one position to another without creating unnecessary forces.

The arrangement of the arms 130 and 140 as described with reference to FIGS. 3 and 4 allows a symmetry of the friction forces. These friction forces are placed in twos and therefore remove the possible dissymmetry of operation in a first direction of rotation, for example the clockwise direction, and in a second direction of rotation, for example the counterclockwise direction.

According to a particular embodiment, when the control button is rotated, one arm is disengaged from a notch while another arm is engaged in a notch.

When the button 14, respectively the buttons 16 and 18, is rotated, the position locators 102 follow the curvature of the notches 25 of the notched ring 24. Thus, they come into contact with the apex separating two successive notches 25 compressing the arms 140 in order to mark the passage from one position to another. Moreover, the elasticity of the arms 140 prevents a position locator 102 from being held in an unstable position on the apex separating two successive notches 25 when the button 14 is rotated.

Alternatively and in order to promote a first direction of rotation, for example the clockwise direction, relative to a second direction of rotation, for example the counterclockwise direction, the shape of the position locators may be asymmetrical.

In a manner similar to the indexing member described with reference to FIG. 2, the placement and positional retention of the indexing member 100 on the board 12 of the control panel 10 are achieved by attachment means, such as screws or rivets, arranged through holes 148 placed in a distributed manner over the frame 104.

The buttons 16 and 18 of FIG. 1 are made in a similar manner and will therefore not be described in detail.

Naturally, the invention is not limited to the exemplary embodiments described above and extends to other variants.

The notched ring is capable of many forms of embodiment. Preferably, it comprises a succession of hollows in an arc of a circle defining the notches. An alternative embodiment of the notched ring consists of a succession of bosses in the form of an arc of a circle which are placed on its periphery and which turn their concavity toward the center of the notched ring, that is to say on the side of its axis of rotation. These bosses thus define, in twos, a series of notches each formed at the join of two consecutive bosses.

It will be understood that the notches may be made over the whole or over only a portion of the notched ring and that the angular gaps defined by these notches may be equal or different, depending on the chosen applications.

The shape of the bosses or of the hollows is capable of many variants, depending on the degree of firmness that the user must feel when he rotates the button. In particular, these may be shapes of the point, flat etc. type or a combination of such shapes.

According to an alternative not shown, it is possible to envisage inverting the members supporting the notches and the position locators. Thus, the present invention also covers the indexing members comprising a support having an outer contour and at least two position locators arranged on the outer contour of the support in an equally-distributed manner.

This exemplary embodiment in particular covers the devices in which the position locators, such as the arms or the walls, are supported by the rotary button 14.

Thus, the position locators 102 are placed instead of the notched ring 24. The notches 25 are arranged on a dedicated zone of the board 12.

Moreover, in order to obtain indexing of still better quality, the indexing member is made of a material other than that used for the manufacture of the button, in particular the member 100 is made of polyoxymethylene (POM) which is a flexible and slippery material making it possible to limit the friction and improve resistance to wear.

As a variant, it is also possible to make this member 100 out of a thin metal that is bent and swaged forming a spring (for example in bronze, stainless steel or steel) either with greasing, or making the free ends of the deformable members (120) which are in contact with the notching with fitted skids made of plastic or of PTF.

The present invention finds a particular application in the control panels incorporated into items of equipment of many technical fields, and notably in the field of equipment for motor vehicles, in particular the heating, ventilation and/or air conditioning installations.

Therefore, the indexing member and the control panel fitted with such an indexing member may be applied to all types of installation having a control panel comprising control members or buttons operated by the user in order to regulate various parameters of the installation.

Evidently the invention is not limited to the embodiments described above and supplied only as an example and covers other variants that those skilled in the art can envisage in the context of the claims and notably all combinations of the various embodiments described above.

1. An indexing member comprising:
a support having a contour; and
at least two position locators arranged on the support,
wherein the position locators are equally distributed over the contour of the support, and are placed on respective deformable members having a free end.

2. The indexing member as claimed in claim 1, wherein the support is a frame having an inner contour.

3. The indexing member as claimed in claim 2, wherein the deformable member is a portion of an inner partition comprising a fixed end attached to the frame and an end that is free of any connection with the frame.

4. The indexing member as claimed in claim 2, wherein the deformable member is an arm comprising a fixed end attached to the frame and an end free of any connection with the frame.

5. The indexing member as claimed in claim 2, wherein at least two deformable members are linked in pairs to the frame by means of a join.

6. The indexing member as claimed in claim 2, wherein at least three deformable members are linked to the frame by means of joins.

7. The indexing member as claimed in claim 2, wherein at least four deformable members are linked in pairs to the frame by means of joins.

8. The indexing member as claimed in claim 2, wherein the frame is in the shape of one of a parallelogram or a circle.

9. The indexing member as claimed in claim 1, wherein the position locators are asymmetrical.

10. The indexing member as claimed in claim 1, wherein the member is made of polyoxymethylene.

11. A control panel comprising:
at least one button;
at least one indexing member comprising:
a support having a contour and at least two position locators arranged on the support,
wherein the at least two position locators are equally distributed over the contour of the support, and are placed on respective deformable members having a free end.

12. The control panel as claimed in claim 11, wherein the at least one button is capable of being rotated manually by a user about respective axes of rotation which extend perpendicularly to the general plane of a board.

13. The control panel as claimed in claim 12, wherein the button comprises a toothed ring comprising notches interacting with the position locators of the indexing member.

14. The control panel as claimed in claim 12, wherein the indexing member is mounted on the board by one of screws or rivets.
